(19) United States
(12) Patent Application Publication
(10) Pub. No.: US 2018/0335157 A1
(43) Pub. Date: Nov. 22, 2018

(54) SAFETY HEAD APPARATUS

(71) Applicant: Nathan C. RASKA, Friendswood, TX (US)

(72) Inventor: Nathan C. RASKA, Friendswood, TX (US)

(21) Appl. No.: 15/982,520

(22) Filed: May 17, 2018

Related U.S. Application Data
(60) Provisional application No. 62/508,920, filed on May 19, 2017.

(51) Int. Cl. F16K 17/16; F16L 23/18; F16K 17/40; F16L 23/032

(52) U.S. Cl. CPC F16K 17/1606; F16L 23/032; F16K 13/04; F16L 23/18

(57) ABSTRACT

A safety head apparatus is provided for a rupture disk. The safety head apparatus has a first safety head flange having a safety head slot, a second safety head flange having a plurality of bolt connectors, and a plurality of safety head bolts for connecting the first safety head flange to the second safety head flange. The plurality of safety head bolts has a plurality of bolt head top surfaces. The plurality of the safety head bolts is connectable to the second safety head flange with the plurality of bolt connectors. A stop member is disposed within the safety head slot. The stop member is secured within the safety head slot. The stop member makes contact with the bolt head top surface when secured in the safety head slot in an assembled position. The plurality of bolt connectors is a plurality of internal threads.

### CROSS-REFERENCE TO RELATED APPLICATIONS

This application claims benefit of U.S. provisional patent application Ser. No. 62/508,920, filed May 19, 2017, which is herein incorporated by reference.

### BACKGROUND

### Field

Embodiments generally relate to a safety head apparatus. More particularly, embodiments relate to a safety head apparatus that has a rupture disk that is clamped between a pair of safety head flanges.

### Description of the Related Art

Rupture disks are designed to be used in pressurized systems. Rupture disks are designed to allow pressurized fluid to vent from one part of a pressurized system when there is an over-pressure situation. Rupture disks are available in a range of different burst ratings. A rupture disk with the appropriate burst rating is selected for an individual pressurized system requiring a burst disk having a specific burst rating. A safety head apparatus includes a rupture disk that is supported between a pair of safety head flanges. The safety head flanges may be connected together by safety head bolts. The safety head flanges may be compressed together with the burst disk between the safety head flanges by tightening the safety head bolts with a torque tool. A recommended amount of torque to be applied to the safety head bolts may be provided for the safety head apparatus. A portion of the burst disk is compressed between the safety head flanges. The torque applied to the safety head bolts may affect the operation of the safety head apparatus.

The safety head apparatus may be installed in a pressurized system by inserting the safety head apparatus within a companion flange apparatus having a pair of companion flanges. The safety head apparatus is disposed between the companion flanges. The safety head apparatus is often pre-assembled and then later transported to be disposed between the companion flanges. Seal members are disposed between the safety head apparatus and the companion flanges. Spiral-wound gaskets are used in contemporary safety head apparatuses. The companion flanges are connected together by companion flange bolts. The companion flange bolts are tightened and the companion flanges are pressed together with the safety head apparatus disposed between the companion flanges. The seal members are compressed between the companion flanges and the safety head flanges to provide a seal between the safety head apparatus and the companion flange apparatus. The recommended tightening torque of the companion flange bolts to secure the safety head and to compress the seal members to form an adequate seal often exceeds the recommended torque of the safety head bolts. As a result, the burst disk in the safety head apparatus is subjected to compressive forces exceeding its recommended operating conditions. The burst disk might become damaged or the burst disk could operate as not intended and rupture at an unintended pressure. Leakage could also occur. The safety head apparatus can become damaged if the burst disk is damaged or if the burst disk bursts at an unintended pressure. For example, the burst disk seating area could become damaged which would require replacement of the safety head apparatus.

The safety head apparatus provides an important safety function for pressurized systems. There is a need for a safety head apparatus that is easy to assemble and that is easy to install within a pressurized system to operate to provide an effective safety function for the pressurized system. Furthermore, there is a need for a safety head apparatus that can prevent or minimize unintended compressive forces on the rupture disk caused by the tightening of the companion flange bolts.

### SUMMARY

Embodiments of the disclosure describe a safety head apparatus for a rupture disk. The safety head apparatus has a first safety head flange having a safety head slot, a second safety head flange having a plurality of bolt connectors, and a plurality of safety head bolts for connecting the first safety head flange to the second safety head flange. The plurality of safety head bolts has a plurality of bolt head top surfaces. The plurality of the safety head bolts is connectable to the second safety head flange with the plurality of bolt connectors. A stop member is disposed within the safety head slot. The stop member is secured within the safety head slot. The stop member makes contact with the bolt head top surface when secured in the safety head slot in an assembled position. The plurality of bolt connectors is a plurality of internal threads.

### BRIEF DESCRIPTION OF THE DRAWINGS

So that the manner in which the above recited features of the present disclosure can be understood in detail, a more particular description of the disclosure, briefly summarized above, may be had by reference to implementations, some of which are illustrated in the appended drawings. It is to be noted, however, that the appended drawings illustrate only selected implementations of this disclosure and are therefore not to be considered limiting of its scope, for the disclosure may admit to other equally effective implementations.

FIG. 1 depicts a perspective view of a safety head apparatus installed in a companion flange apparatus according to one embodiment.

FIG. 2 depicts an exploded view of the safety head apparatus and companion flange apparatus according to one embodiment.

FIG. 3 depicts a partial cross-sectional view of the safety head apparatus according to one embodiment.

FIG. 4 depicts a cross-sectional view of the safety head apparatus installed in the companion flange apparatus according to one embodiment.

FIG. 5 depicts a partial cross-sectional view of the safety head apparatus installed between companion flanges according to one embodiment.

FIG. 6 depicts a partial cross-sectional view of the safety head apparatus installed between companion flanges according to one embodiment.

To facilitate understanding, identical reference numerals have been used, wherever possible, to designate identical elements that are common to the Figures. Additionally, elements of one implementation may be advantageously adapted for utilization in other implementations described herein.

### DETAILED DESCRIPTION

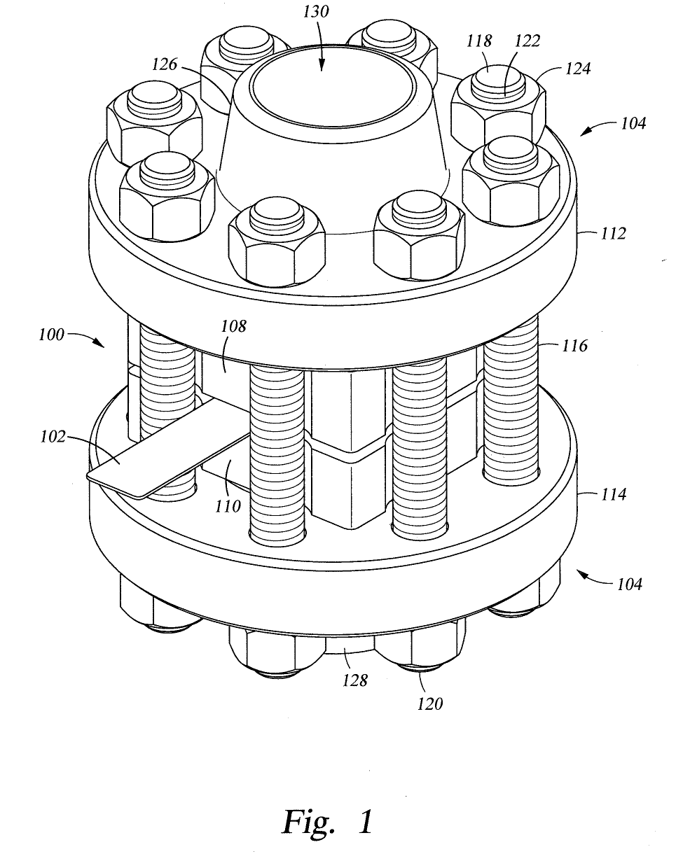

FIG. 1 depicts a perspective view of a safety head apparatus 100 installed in a companion flange apparatus 104 according to one embodiment. A rupture disk 102, also referred to as a burst disk, is disposed within the safety head apparatus 100. The safety head apparatus 100 has a safety head flange 108 and a safety head flange 110. The companion flange apparatus 104 has a companion flange 112, a companion flange 114, and companion flange bolts 116 having companion flange bolt external threads 122. The companion flange 112 has a companion flange housing 126 with a companion flange opening 130 extending through the companion flange housing 126 and the companion flange 112. The companion flange 114 has a companion flange housing 128.

The safety head apparatus 100 is disposed between the companion flanges 112, 114 in an installed position, as shown in FIG. 1. The companion bolts extend through the companion flanges with a first bolt end 118 located above the companion flange 112 and a second bolt end 120 located below the companion flange 114. The companion flange bolts 116 have external threads. Companion flange nuts 124 are connected to the companion flange bolts 116 by threading the companion flange nuts 124 onto the companion flange bolts 116 proximate the first bolt end 118 and the second bolt end 120. The companion flange nuts are tightened to compress the companion flanges 112, 114 toward each other with the safety head flanges 108, 110 disposed between the companion flanges 112, 114.

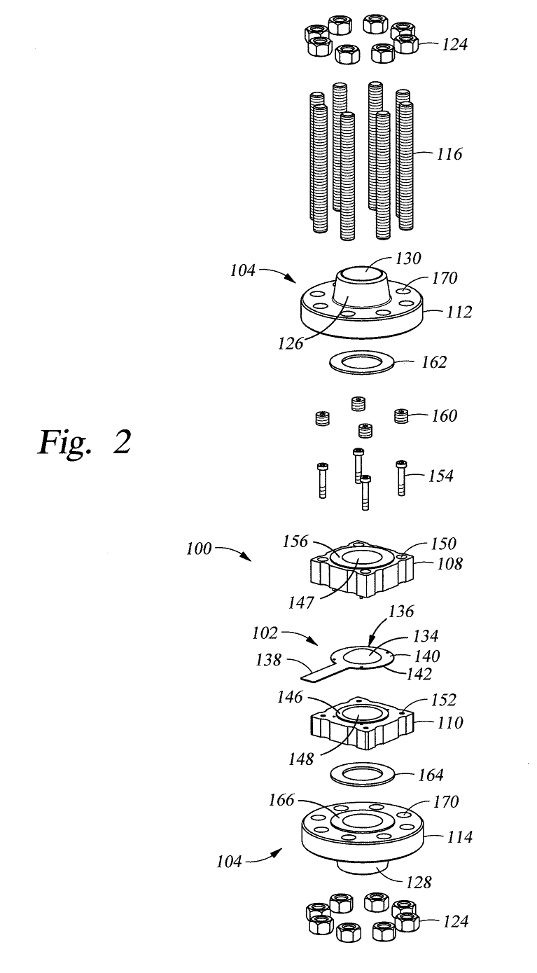

FIG. 2 depicts an exploded view of the safety head apparatus 100 and companion flange apparatus 104 according to one embodiment. The rupture disk 102 may be a conventional rupture disk. The rupture disk 102 has a disk central member 134 that has a convex shape, a disk ring 136, and a disk handle 138. The disk ring 136 has a disk ring top surface 140 and a disk ring bottom surface 142.

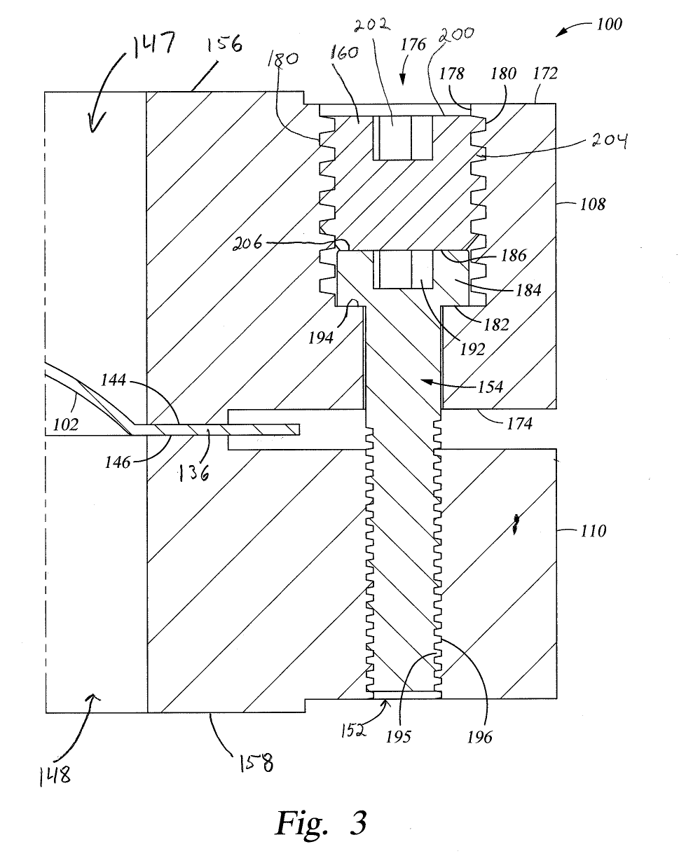

The safety head flanges 108, 110 each have a safety head disk surface 146 that is disposed on an inner surface of the safety head flanges. The disk ring 136 sits on the safety head disk surface 146 when the safety head flanges 108, 110 are connected together in an assembled position. A safety head central passage 147 extends through the safety head flange 108. A safety head central passage 148 extends through the safety head flange 110. The safety head flanges 108, 110 have safety head bolt passages 150, 152. Safety head bolts 154 extend through the safety head bolt passages 150, 152 when connecting the safety head flanges 108, 110. Safety head bolt passage 150 is also the safety head slot 176. A safety head seal surface 156 is disposed on a top surface of the safety head flange 108. A safety head seal surface 158, shown in FIG. 3, is disposed on a bottom surface of the safety head flange 110.

The safety head apparatus 100 includes a stop member in the form of a stop nut 160. The stop nut 160 may be cylindrical in shape. The stop nut may be made of metal. In other embodiments, the stop nut may be made of non-metal materials.

Disposed between the safety head apparatus and the companion flange apparatus 104 are safety seal members 162, 164. The safety seal members 162, 164 may be in the form of a safety gasket. The safety seal members 162, 164 may be spiral-wound gaskets.

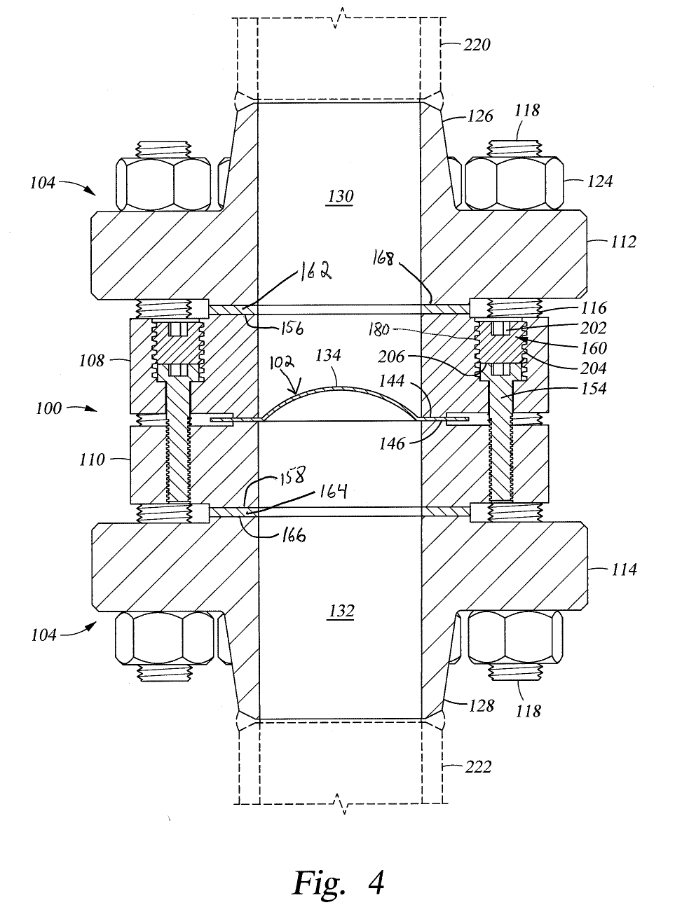

The companion flanges 112, 114 include a companion flange seal surface 166 and a companion flange seal surface 168, shown in FIG. 4. Extending through the companion flanges 112, 114 are companion flange bolt openings 170.

FIG. 3 depicts a partial cross-sectional view of the safety head apparatus 100 according to one embodiment. The safety head apparatus 100 is shown in FIG. 3 in an assembled position with the rupture disk 102 disposed between the safety head flanges 108, 110. The rupture disk 102 blocks fluid flow through the safety head apparatus 100 when the rupture disk 102 is in a non-ruptured state by blocking fluid flow through safety head central passages 147, 148. A portion of the disk ring 136 is disposed between the safety head disk surfaces 144, 146.

The safety head bolt 154 is elongated and includes a bolt head 184 having a bolt head bottom surface 194 and a bolt head top surface 186. A bolt head socket 192 extends into the bolt head 184 through the bolt head top surface 186. The safety head bolts 154 have external threads 195. In the embodiment shown in FIG. 3, the external threads 195 extend from a portion of the safety head bolt 154 that is disposed below a safety head bottom surface 174 to a safety head bolt end opposite the bolt head 184. In some embodiments, external threads 195 are disposed on the safety head bolt shaft from the bolt head bottom surface 194 to the safety head bolt end opposite the bolt head 184. The external threads 195 are configured so that the safety head bolts 154 are threaded in internal threads 196 of a safety head bolt passage 152 in the safety head flange 110. The internal threads 196 form a bolt connector in the safety head flange 110. The safety head bolts 154 extend through the safety head flanges 108, 110 to connect the safety head flanges 108, 110 together. The plurality of the safety head bolts 154 are connectable to the safety head flange 110 with the internal threads 196.

The safety head bolts 154 are tightened using a torque tool such as an Allen wrench to a selected torque. The safety head bolts 154 compress the safety head flanges 108, 110 together so that the disk ring 136 is compressed between the safety head disk surfaces 144, 146. By using a selected amount of torque to tighten the safety head bolts 154, a selected amount of compressive force is applied to the disk ring 136 of the rupture disk 102. The bolt head bottom surface 194 abuts against the slot bottom surface 182 of the safety head slot 176. The safety head slot 176 has a slot internal wall 178 with slot internal threads 180.

After the safety head bolts 154 are tightened, the stop nut 160 may be inserted into the safety head slot 176 of the safety head flange 108. The stop nut 160 has stop nut external threads 204. The stop nut external threads 204 are threaded into the slot internal threads 180. The stop nut 160 has a stop member top surface 200, a stop member socket 202, and a stop member bottom surface 206. The stop member socket 202 extends into the stop nut 160 through the stop member top surface 200. The stop member socket 202 is configured to accept a torque tool for applying torque to the stop nut 160. The stop nut 160 is threaded into the slot internal threads 204 by inserting the torque tool in the stop member socket 202 and rotating the stop nut 160. The stop nut 160 is tightened so that the stop member bottom surface 206 of the stop nut 160 abuts against the bolt head top surface 186.

In other embodiments, the stop member bottom surface 206 may be in contact with another portion of the safety head bolt 154. For example, in some embodiments the stop member bottom surface 206 may be in contact with a contact surface within the bolt head socket 192. In alternative embodiments, the stop nut 160 is configured to have at least some portion of the stop nut 160 in contact with a portion of the safety head bolt 154 when the safety head apparatus 100 is in an assembled position. The stop nut 160 may have a torque range so that a selected amount of torque is applied to the stop nut 160 during installation of the stop nut 160.

The stop member top surface 200 is disposed within the safety head slot 176 so that the stop member top surface 200 is below a safety head top surface 172 that surrounds the safety head slot 176. After the stop nut 160 is tightened, the safety head apparatus 100 is in an assembled position. In some embodiments, the stop member top surface 200 is even with or above the safety head top surface 172.

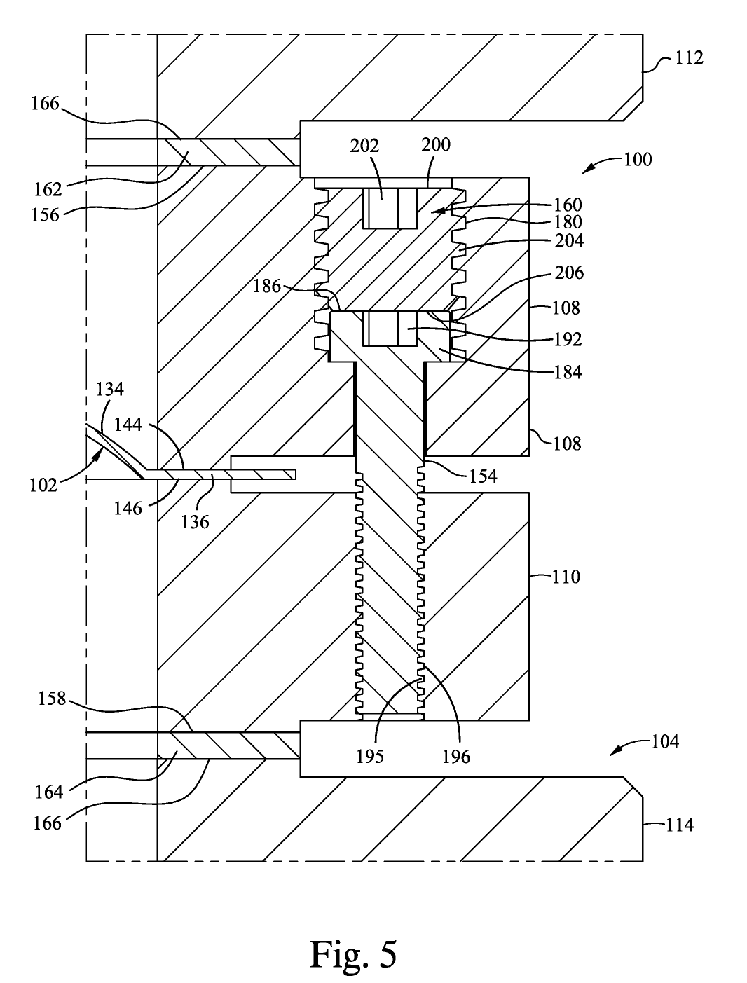

Referring to FIG. 4 and FIG. 5, the safety head apparatus 100 may be installed in the companion flange apparatus 104 so that the safety head apparatus 100 is installed in a pressurized system. The companion flanges 112, 114 are connected to the pressurized system in a conventional manner by a top pipe 220 and a bottom pipe 222 shown in dashed lines. A system fluid path extends between the top pipe 220 and bottom pipe 222 through the companion flange openings 130, 132 and the safety head apparatus 100. The rupture disk 102 blocks the system fluid path when in a non-ruptured state. The companion flange bolts 116, shown in FIG. 4, extend through the companion flanges 114, 116. The companion flange nuts 124 may be tightened with a torque tool to compress the companion flanges 114, 116 towards one another. The torque tool may be a wrench. A selected amount of torque may be applied to the companion flange nuts 124. The selected amount of torque for the companion flange nuts 124 may be provided by a manufacturer of the companion flange apparatus 104. The torque applied to the companion flange nuts 124 may exceed the torque applied to the safety head bolts 154.

As the companion flange nuts 124 are tightened, a compressive force is applied to the companion flanges 114, 116. In particular, the companion flange seal surfaces 166 are compressed inwardly towards the safety head seal surfaces 156, 158 of the safety head flanges 108, 110. The safety seal members 162, 164 are disposed between the companion flange seal surfaces 166 and the safety head seal surfaces 156, 158 and are compressed to form a seal between the safety head apparatus 100 and the companion flange apparatus 104.

Compressive force from the companion flanges 112, 114 is also applied to the safety head seal surfaces 156, 158 of the safety head flanges 108, 110. The stop nuts 160 and the safety head bolts 154 together help prevent or reduce the compressive force from the companion flanges 112, 114 from being transferred to the disk ring 136 of the rupture disk 102. By reducing the compressive force that is transferred from the companion flanges 112, 114 to the rupture disk 102 through use of the stop nuts 160 and the safety head bolts 154, unintended compressive forces on the rupture disk 102 will be minimized or prevented. Unintended compressive forces on the rupture disk 102 may cause the rupture disk 102 to operate as not intended and rupture at an unintended fluid pressure of the pressurized system being protected by the rupture disk 102.

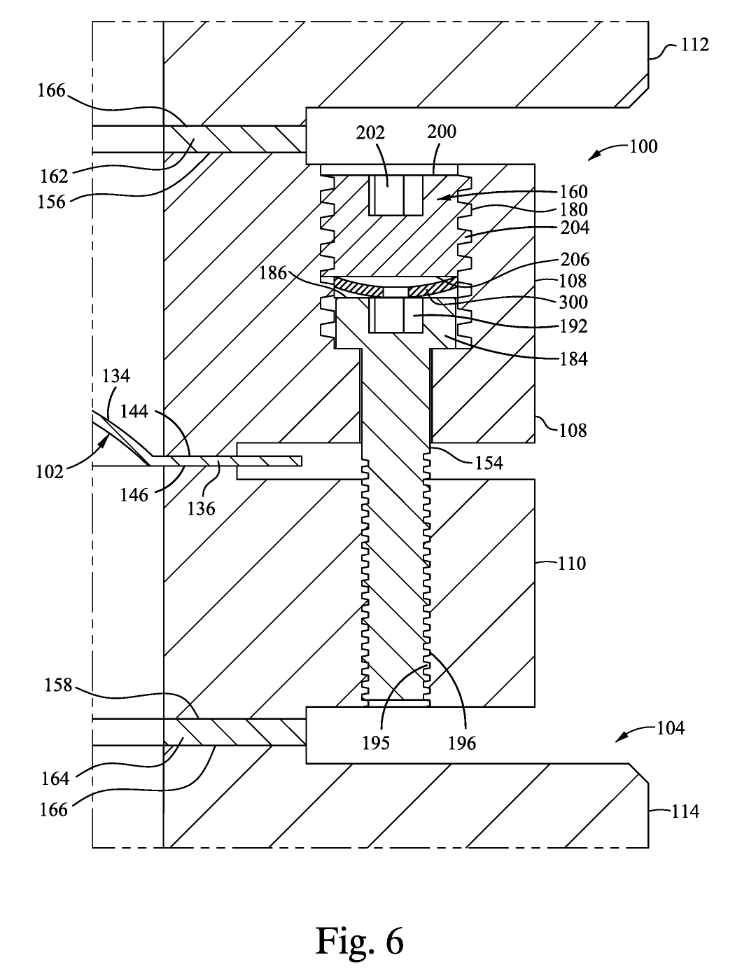

FIG. 6 illustrates an alternative embodiment of the safety head apparatus 100. The embodiment of the safety head apparatus differs from the previously described embodiments in that a spring member 300 is disposed between the bolt head top surface 186 of the safety head bolt 154 and the stop member bottom surface 206. The spring member 300 may be a spring, a wave spring, a wave washer, or a disc spring such as a Belleville washer. The spring member 300 may also be partially disposed in a blind bore in the stop nut 160 having an opening at the stop member bottom surface 206. The stop nuts 160, spring member 300, and the safety head bolts 154 together help prevent or reduce the compressive force from the companion flanges 112, 114 from being transferred to the disk ring 136 of the rupture disk 102. By reducing the compressive force that is transferred from the companion flanges 112, 114 to the rupture disk 102 through use of the stop nuts 160, spring member 300, and the safety head bolts 154, unintended compressive forces on the rupture disk 102 will be minimized or prevented.

Alternative embodiments for the stop nut 160 may also be used. For example, a stop ring may replace the stop nut 160. The stop ring may be inserted into the safety head slot 176 and positioned against the bolt head top surface 186. The stop ring may then be secured in the safety head slot 176 against or proximate the bolt head top surface 186. For example, the stop ring could be configured to fit within the slot internal threads 180 to secure the stop ring in place. In another alternative embodiment for stop nut 160, a set screw could replace the stop nut 160. For example, the set screw could extend though a side wall of safety head flange 108 and extend into the safety head slot 176. An end of the safety head slot 176 may abut against or proximate to the bolt head top surface 186 so that the transfer of compressive forces from the companion flanges 112, 114 are reduced or prevented.

While the foregoing is directed to embodiments of the present disclosure, other and further embodiments of the disclosure may be devised without departing from the basic scope thereof, and the scope thereof is determined by the claims that follow.

1. A safety head apparatus, comprising:
a first safety head flange having a plurality of safety head slots;
a second safety head flange having a plurality of bolt connectors;
a plurality of safety head bolts connecting the first safety head flange to the second safety head flange, wherein each of the safety head bolts have a plurality of bolt head top surface, and wherein the plurality of the safety head bolts are connectable to the second safety head flange with the plurality of bolt connectors;
a stop member disposed within the safety head slot, wherein the stop member is secured within the safety head slot, and wherein the stop member makes contact with the safety head bolt when secured in the safety head slot in an assembled position.

2. The safety head apparatus of claim 1, wherein the plurality of bolt connectors are a plurality of internal threads.

3. The safety head apparatus of claim 1, further comprising:
a burst disk having a central member and a disk ring, wherein the disk ring is disposed between the first safety head flange and the second safety head flange.

4. The safety head apparatus of claim 1, wherein the stop member makes contact with the bolt head top surface.

5. The safety head apparatus of claim 1, wherein the first safety head flange has a first safety head seal surface and the second safety head flange has a second safety head seal surface.

6. The safety head apparatus of claim 5, wherein:
the safety head apparatus is disposed between a companion flange apparatus comprising:
a first companion flange having a first companion flange seal surface;
a second companion flange having a second companion flange seal surface; and
a plurality of companion flange bolts connecting the first companion flange to the second companion flange;
wherein a first seal member is disposed between the first companion flange seal surface and the first safety head seal surface and a second seal member is disposed between the second companion flange seal surface and the second safety head seal surface.

7. The safety head apparatus of claim 6, wherein at least one of the first and second seal members is a spiral-wound gasket.

8. The safety head apparatus of claim 6, wherein the first companion flange is attached to a first tubular and the second companion flange is attached to a second tubular.

9. A safety head apparatus, comprising:
a first safety head flange having a safety head slot;
a second safety head flange having a plurality of bolt connectors;
a plurality of safety head bolts connecting the first safety head flange to the second safety head flange, and wherein each of the safety head bolts are connectable to the second safety head flange with the plurality of bolt connectors;
a stop member and a spring member disposed within the safety head slot, wherein the stop member is secured within the safety head slot, and wherein the spring member is between the stop member and the safety head bolt when secured in the safety head slot in an assembled position.

10. The safety head apparatus of claim 9, further comprising:
a burst disk having a central member and a disk ring, wherein the disk ring is disposed between the first safety head flange and the second safety head flange.

11. The safety head apparatus of claim 9, wherein the first safety head flange has a first safety head seal surface and the second safety head flange has a second safety head seal surface.

12. The safety head apparatus of claim 11, wherein:
the safety head apparatus is disposed between a companion flange apparatus comprising:
a first companion flange having a first companion flange seal surface;
a second companion flange having a second companion flange seal surface; and
a plurality of companion flange bolts connecting the first companion flange to the second companion flange;
wherein a first seal member is disposed between the first companion flange seal surface and the first safety head seal surface and a second seal member is disposed between the second companion flange seal surface and the second safety head seal surface.

13. The safety head apparatus of claim 12, wherein at least one of the first and second seal members is a spiral-wound gasket.

14. The safety head apparatus of claim 9, wherein the plurality of bolt connectors are a plurality of internal threads.

15. A safety head system, comprising:
a safety apparatus having:
a first safety head flange having a plurality of safety head slots and a first safety head seal surface;
a second safety head flange having plurality of bolt passageways and a second safety head seal surface;
a plurality of safety head bolts connecting the first safety head flange to the second safety head flange, wherein the plurality of safety head bolts are disposed in the plurality of safety head slots and the plurality of safety head passageways in an assembled position; and
a plurality of stop members disposed in the plurality of safety head slots in an assembled position;
a companion flange apparatus having:
a first companion flange having a first companion flange seal surface;
a second companion flange having a second companion flange seal surface; and
a plurality of companion flange bolts connecting the first companion flange to the second companion flange;
a first seal member;
a second seal member; and
wherein the safety head apparatus is disposed between the first companion flange seal surface and the second companion flange seal surface, and wherein the first seal member is disposed between the first companion flange seal surface and the first safety head seal surface and the second seal member is disposed between the second companion flange seal surface and the second safety head seal surface.

16. The safety head system of claim 15, wherein at least one of the first and second seal members is a spiral-wound gasket.

17. The safety head system of claim 15, further comprising:
a burst disk having a central member and a disk ring, wherein the disk ring is disposed between the first safety head flange and the second safety head flange.

18. The safety head system of claim 15, wherein the stop member makes contact with the safety head bolt when secured in the safety head slot in the assembled position.

19. The safety head system of claim 15, further comprising a spring member disposed between the stop member and the safety head bolt.

20. The safety head system of claim 15, wherein the first companion flange is attached to a first tubular and the second companion flange is attached to a second tubular.
